(19) United States
(12) Patent Application Publication
(10) Pub. No.: US 2011/0064564 A1
(43) Pub. Date: Mar. 17, 2011

(54) Pumps or Generators with Flow-Through Impellers

(75) Inventor: John R. Kochan, JR., Naperville, IL (US)

(73) Assignee: Metropolitan Industries, Inc., Romeoville, IL (US)

(21) Appl. No.: 12/881,675

(22) Filed: Sep. 14, 2010

Related U.S. Application Data
(60) Provisional application No. 61/243,418, filed on Sep. 17, 2009.

(51) Int. Cl. F04D 29/38; F04B 17/03; F03B 13/10

(52) U.S. Cl. 415/115; 417/423.7; 290/54

(57) ABSTRACT

An axial flow pump includes a perforated impeller through which fluid being pumped flows. The pump can carry a stator which can interact with magnetic elements rotatably carried with the impeller to produce rotation thereof.

### CROSS-REFERENCE TO RELATED APPLICATION

This application claims the benefit of the filing date of U.S. Provisional Application Ser. No. 61/243,418 filed Sep. 17, 2009 and entitled Pump, Fan or Generator With Flow-through Rotor which is hereby incorporated herein by reference.

### FIELD

The invention pertains to pumps, fans or generators. More particularly, the invention pertains to such structures with axial fluid flow and with flow-through impellers or rotors.

### BACKGROUND

A wide variety of pumps are known. Such structures suffer at times from being complex and expensive to manufacture. It would be useful to simplify such structures which would not only reduce manufacturing costs, but could also result in more reliable products.

### BRIEF DESCRIPTION OF THE DRAWINGS

FIG. 1 is a side sectional view of a pump, fan or generator which embodies the invention;

FIG. 2A is a top plan view of a flow-through impeller or rotor usable with the unit of FIG. 1;

FIG. 2B is a side elevational view of the impeller or rotor of FIG. 2A; and

FIG. 3 is a side sectional view of another embodiment of the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In one embodiment of the invention, an in-line pump, fan or generator incorporates a flow-through, perforated or slotted, rotor, fan or impeller which is oriented to be substantially perpendicular to a desired direction of flow of a fluid. Exemplary units which embody the invention include an external, hollow, housing which could be attached to a source of fluid, for example a pipe.

In one type of unit, a rotatable impeller, fan or rotor is carried in the housing and rotates generally perpendicular to the flow of fluid through the housing in response to applied electrical signals. In another aspect of the invention, the rotor or impeller could be driven by a flow of fluid through the housing thereby generating an electrical output from an adjacent stator which surrounds the rotor.

In embodiments of the invention, the outside edge of the impeller, fan, or rotor, could be lined with rare earth magnets. The housing could have a center pin for the rotor to rest on when not energized. An electrical coil (stator) is located around the outside of the housing in line with the rotor and when called for energized. The rotor would then free float in the magnetic field and rotate accordingly eliminating the need for bearings seal etc. Since such structures are in line they can be used in any configuration and can replace many items including zone valves.

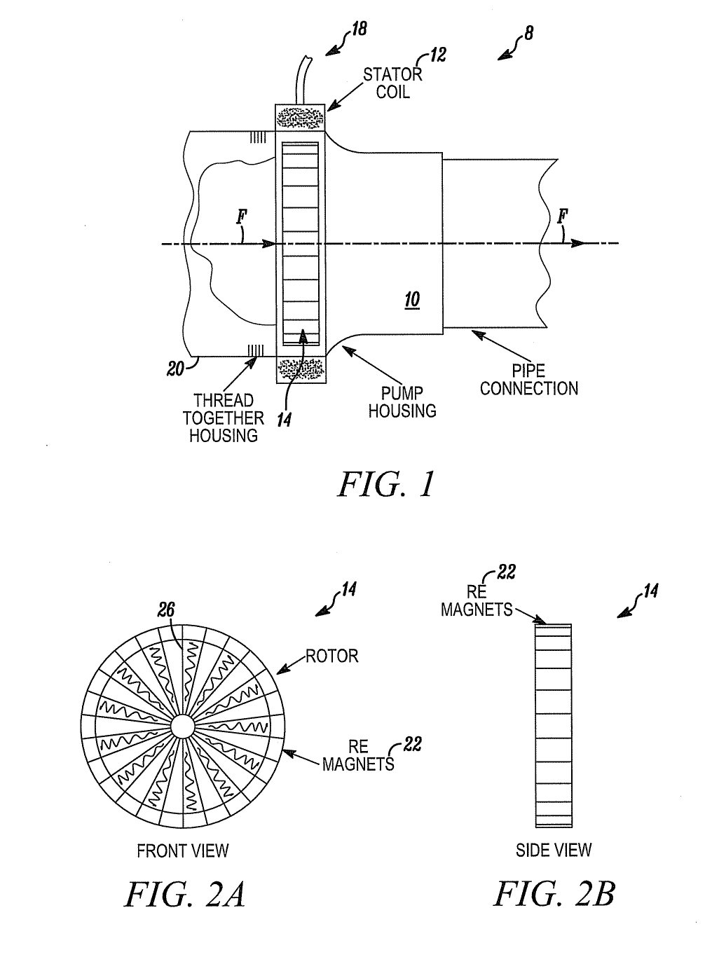

FIG. 1 illustrates aspects of embodiments of the invention. In a unit 8 in accordance with the invention, a hollow housing 10 carries an external stator 12 and an internal rotatable rotor, impeller or fan indicated generally at 14. When the stator 12 is energized via port 18, the rotor 14 rotates and pulls fluid from a source, such as pipe 20 (shown partly broken away), in a direction F into and through the housing 10. In the absence of pipe 20, the housing 10 could be exposed to ambient air in a region and the unit would function as an exhaust fan.

FIGS. 2A, 2B illustrate aspects of the flow-through rotor or impeller 14. In a disclosed embodiment, the edges of the rotor 14 could carry rare earth magnets, indicated generally at 22, which would interact with the field set up by stator 12 thereby causing the rotor, fan, or impeller 14 to rotate. The rotor 14 could be slotted, indicated at 26 enabling fluid to flow therethrough as the rotor 14 rotates. Alternately, when the unit 8 is being driven by the flow F of fluid against the rotor or impeller 14, causing same to rotate, an electrical output can be produced by the stator 12 at port 18.

Rotor 14 can be carried on a centrally located support or pin, not shown, in the housing 10 to maintain its alignment. In alternate embodiments, such a support or pint may not be needed. Advantageously unit 8 does not require seals, gaskets or bearings.

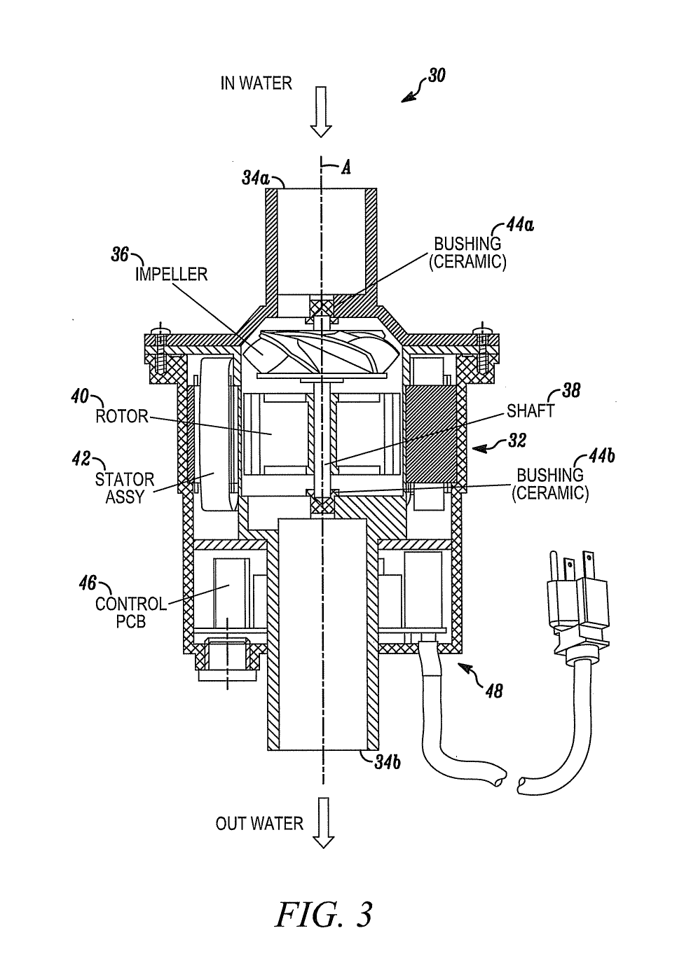

FIG. 3 illustrates another pump 30 which embodies the invention. Pump 30 includes a hollow exterior housing generally indicated at 32. A fluid, such as water, or air, could flow into the pump 30 at an inflow port 34a, flow axially through the housing 32 and exit from an outflow port 34b.

A slotted, or flow-through impeller 36 is carried on a shaft 38 in housing 32 and rotates in a plane which is generally perpendicular to a central axis A along which the fluid flows through the pump 30. Impeller 36 could be formed with a plurality of openings therethrough, as in rotor 14 of FIG. 2A, without limitation. Neither the shape, nor the number of openings through the impeller or rotor 36 are limitations of the invention. Shaft 38 carries a rotor 40 which can be driven to rotate by an electrically actuated stator assembly 42.

Bushings 44a, 44b can support the shaft 38 for rotary motion in the housing 32. Control circuits 46 carried in housing 32 can control the operation of the pump and can be electrically activated, along with the stator assembly 42 via electrical input port 48.

Those of skill will understand that the structure of FIGS. 1, 3 could be used as a fan or an electrical generator. In the case of operation as a fan, the structures would function similarly to the above described pump operation. To operate in a generator mode, a flow of fluid, water for example, can be forced through the flow through impeller, or rotor causing rotation and thereby generating an electrical output at the port 48 (which in this embodiment becomes an electrical output port.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A pump comprising:
a hollow housing, the housing having a fluid inflow port and a fluid outflow port with a substantially axial flow path therebetween;
a flow-through impeller rotatably carried in the housing for rotation generally perpendicular to the flow path; and
circuitry to rotate the impeller thereby producing a flow of fluid through the housing.

2. A pump as in claim 1 which further includes an electrically activated stator carried by the housing.

3. A pump as in claim 2 which includes a magnetic element carried for rotation with the impeller and responsive to the electrically activated stator to produce a rotation of the impeller.

4. A pump as in claim 3 where the element is selected from a class which includes at least, a rotor, or a plurality of magnets.

5. A pump as in claim 4 which includes an axially oriented rotatable shaft which carries the impeller and the element.

6. A pump as in claim 5 which includes at least one bearing which rotatably engages the shaft.

7. A pump as in claim 4 where the magnets are carried, spaced apart on a circumferential surface of the impeller.

8. A pump as in claim 4 which includes control circuits to energize at least the stator.

9. A pump as in claim 1 where the circuitry can include a programmed control processor and executable instructions.

10. A pump as in claim 9 where the processor and instructions when executed monitor pump operation and adjust electrical signals applied to a stator carried by the housing.

11. An electrical generator comprising:
a hollow housing, the housing having a fluid inflow port and a fluid outflow port with a substantially axial flow path therebetween;
a flow-through impeller rotatably carried in the housing for rotation generally perpendicular to the flow path; and
circuitry responsive to rotation of the impeller thereby producing an electrical output from the housing.
